(19) United States
(12) Patent Application Publication
(10) Pub. No.: US 2023/0007102 A1
(43) Pub. Date: Jan. 5, 2023

(54) REQUEST SCHEDULING

(71) Applicant: Telefonaktiebolaget LM Ericsson (publ), Stockholm (SE)

(72) Inventors: Cristian Klein, Umeå (SE); Ahmed Hassan, Umeå (SE)

(21) Appl. No.: 17/777,648

(22) PCT Filed: Nov. 20, 2019
(86) PCT No.: PCT/EP2019/081928

§ 371 Date: May 18, 2022

(51) Int. Cl. H04L 67/62; G06F 9/50

(52) U.S. Cl. CPC H04L 67/62; G06F 9/505

(57) ABSTRACT

A method for end-to-end request scheduling for a distributed system comprising a plurality of hosts via which one or more requests are transmitted. The method comprises: receiving the one or more requests; assigning global scheduling information to each of the one or more requests; transmitting, for each of the one or more requests, respectively assigned global scheduling information with the request, such that respective global scheduling information is made available to a local scheduling unit corresponding to a host via which each of the plurality of requests is transmitted; and determining, for each of one or more one or more requests received at each of the plurality of hosts, an order in which at least one of: a computation operation, a communication operation, and an input/output operation associated with the request is performed, based on the global scheduling information assigned to the respective request.

### TECHNICAL FIELD

The present disclosure relates to the field of request scheduling. In particular, the present disclosure relates to the field of end-to-end request scheduling for a distributed system which includes a number of hosts.

### BACKGROUND

Several studies of users' Quality-of-Experience highlight that large application response times lead to a decrease in revenue. For example, many companies found that increased latency leads to dropped traffic and reduced sales.

Besides attempts to reduce the average response time for applications, controlling tail response times (e.g. the 99^{th} percentile response times) of web applications is also central to providing good Quality-of-Service for web applicant clients. Due to the complexity of the software and hardware used to build distributed systems, events such as scheduling delays, garbage collection, energy saving, and background tasks may cause “hiccups” in the execution of an application, which leads to some requests being served orders of magnitude slower than on average. In particular, scheduling delays are a major source of increased tail response times occurring on the operating system level. Operating system scheduling delays cause long tail response times as most operating systems schedule tasks, such as runnable threads or backlogged network packets, in an arbitrary order based on interrupts, instead of an order that minimises tail response time.

### SUMMARY

Many currently available techniques focus on reducing delays for single application components, for example by replicating requests. Techniques for doing so include dedicating a separate CPU core to network interrupts, using real-time priority and changing the default scheduler from Completely Fair Scheduler (CFS) to Borrowed Virtual Time (BVT). However, such techniques have not been validated on applications composed of multiple components, as featured by modern micro-service-based applications. In fact, one can show using queuing theory that, without specifically addressing the distributed nature of multi-tiered applications, modularising a monolithic application leads to increased tail response times.

Thus, there remains a need for application-agnostic end-to-end request scheduling techniques. Embodiments of the present disclosure implement an end-to-end scheduling method which can reduce tail response times in micro-service-based applications. In more detail, embodiments of the present disclosure track information about an original user request throughout the distributed system, both horizontally (along the distribution application call-chain) and vertically (from the micro-service request to the thread serving the request to the CPU scheduler). This allows CPU schedulers to complement the information about runnable threads with information about the user requests they are servicing, in order to enforce the same ordering of work as if the application was monolithic.

One aspect of the present disclosure provides a method for end-to-end request scheduling for a distributed system which comprises a plurality of hosts via which one or more requests are transmitted. The method comprises: receiving the one or more requests; assigning global scheduling information to each of the one or more requests; transmitting, for each of the one or more requests, respectively assigned global scheduling information with the respective request, such that respective global scheduling information is made available to a local scheduling unit corresponding to a host via which each of the plurality of requests is transmitted; and determining, for each of one or more one or more requests received at each of the plurality of hosts, an order in which at least one of: a computation operation, a communication operation, and an input/output operation associated with the respective request is performed, wherein the determination is based on the global scheduling information assigned to the respective request.

Another aspect of the disclosure provides a scheduling system for performing end-to-end request scheduling at a distributed system comprising a plurality of hosts. The scheduling system extends a network communication protocol implemented by the distributed system and comprises: an entry-point configured to receive one or more requests and to assign global scheduling information to each of the one or more requests, and a plurality of local scheduling units, wherein each of the plurality of local scheduling units corresponds to one of the plurality of hosts in the distributed system. The scheduling system is configured to extend the network communication protocol to perform the following: transmitting, for each of the one or more requests, respectively assigned global scheduling information with the respective request via a protocol extension associated with the network communication protocol, such that the respective global scheduling information is made available to a local scheduling unit corresponding to a host via which the respective request is transmitted. Each of the plurality of local scheduling units is configured to determine, for each of one or more requests received at the corresponding host, an order in which at least one of a computation operation, a communication operation, and an input/output operation associated with the respective request is performed, wherein the determination is based on the global scheduling information assigned to the respective request.

Another aspect of the disclosure provides a computer program product comprising a computer readable medium, the computer readable medium having computer readable code embodied therein, the computer readable code being configured such that, on execution by a suitable computer or processor, the computer or processor is caused to perform the method as described herein.

### BRIEF DESCRIPTION OF THE DRAWINGS

For a better understanding of examples of the present invention, and to show more clearly how the examples may be carried into effect, reference will now be made, by way of example only, to the following drawings in which:

FIG. 1 is a block diagram of a distributed system capable of end-to-end request scheduling according to embodiments of the disclosure;

FIG. 2 is a schematic diagram illustrating the structure of an execution stack, according to embodiments of the disclosure;

FIG. 3 is a schematic diagram illustrating the structure of a network communication protocol stack, according to embodiments of the disclosure;

FIG. 4 is a flowchart illustrating a method for end-to-end request scheduling for a distributed system according to embodiments of the disclosure;

FIG. 5 is a graph illustrating results achieved by the method with increasing load, according to embodiments of the disclosure;

FIG. 6 is a graph illustrating results achieved by the method with increasing number of CPUs and constant load, according to embodiments of the disclosure;

FIG. 7 is a graph illustrating results achieved by the method with co-located components, according to embodiments of the disclosure;

FIG. 8 is a graph illustrating results achieved by the method according to embodiments of the disclosure as compared with alternative approaches; and

FIG. 9 is a graph illustrating results achieved by the method over three physical machines, according to embodiments of the disclosure.

### DETAILED DESCRIPTION

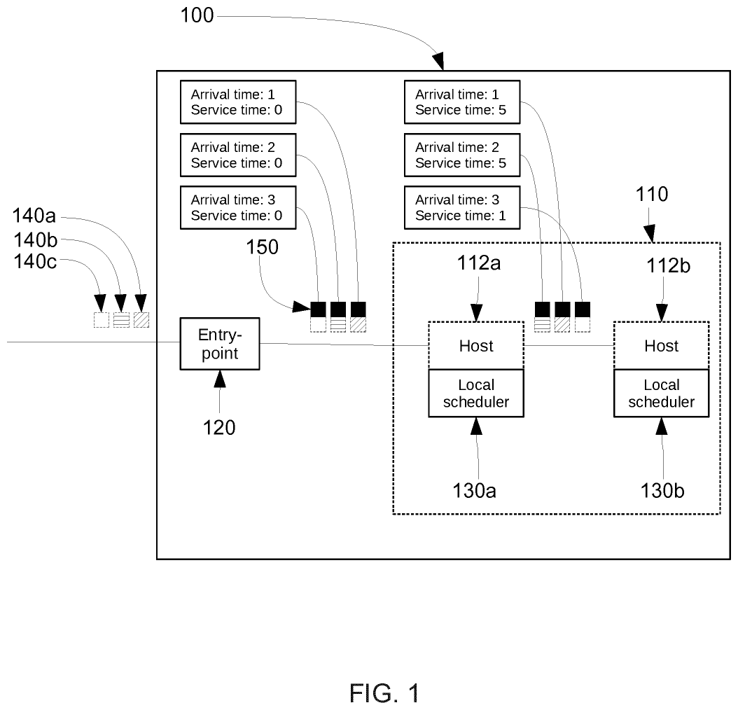

FIG. 1 is a block diagram of a scheduling system capable of end-to-end request scheduling according to embodiments of the disclosure. Specifically, the scheduling system 100 is capable of performing end-to-end request scheduling at a distributed system 110, which comprises a plurality of hosts via which one or more requests is transmitted. The end-to-end request scheduling is based on global transmission of scheduling information, which will be referred to as “global scheduling information” hereafter. The term “global” in this context refers to information that is available to the plurality of hosts in the distributed system 110 (and components that use such information), in contrast to “local” information that is available to a single host (and components that use such information). In FIG. 1, the plurality of hosts of the distributed system 110 are represented as a first host 112a and a second host 112b. It will be appreciated that in some embodiments there may be provided more than two hosts at the distributed system 110. In the present embodiment, the scheduling system 100 extends a network communication protocol implemented by the distributed system 110.

The scheduling system 100 comprises an entry-point 120 and a plurality of local scheduling units 130a, 130b. The entry-point 120 is configured to receive the one or more requests 140a, 140b, 140c, and to assign global scheduling information 150 to each of the one or more requests 140a, 140b, 140c. The global scheduling information can either be generated when the request arrives to the distributed system 110, or produced by a trusted entity outside the distributed system 110. In some embodiments, the entry-point 120 may be configured to discard, for each of the plurality of requests, information associated with an arrival time of the request. This discarding operation may be performed prior to assigning of the global scheduling information. Thus, the entry-point 120 can provide security in the manner that potentially malicious or suspicious data contained in the information associated with arrivals times can be discarded.

Each of the plurality of local scheduling units 130a, 130b corresponds to one of the plurality of hosts 112a, 112b in the distributed system 110. In the present embodiment, a first local scheduling unit 130a of the plurality of local scheduling units corresponds to the first host 112a, and a second local scheduling unit 130b of the plurality of local scheduling units corresponds to the second host 112b. In some embodiments, each of the plurality of local scheduling units 130a, 130b implemented in at least one of a level of an execution stack. The execution stack may comprise at least one of the following levels: a runtime environment, an operating system, and a hypervisor. Moreover, in some embodiments each of the plurality of local scheduling units may be implemented in a single level of the execution stack, without requiring any support or modifications in the other levels of the execution stack. For example, in some embodiments each of the plurality of local scheduling unit may be implemented in a single level of the execution stack without requiring further interface or functionality provided by a different level of the execution stack.

In some embodiments, the global scheduling information 150 assigned to each of the one or more requests 140 may comprise an arrival time of the respective request at the entry-point 120. This is illustrated in FIG. 1 which shows that in the global scheduling information 150 for each of the requests 140a, 140b, 140c, an “arrival time” (of the request at the entry-point 120) is provided. For example, for a first request 140a the global scheduling information 150 comprises an arrival time represented by “1”, for a second request 140b the global scheduling information 150 comprises an arrival time represented by “2”, and for a third request 140c the global scheduling information 150 comprises an arrival time represented by “3”. In this case, the number representing the arrival time indicates an order in which the request is received at the entry-point 120.

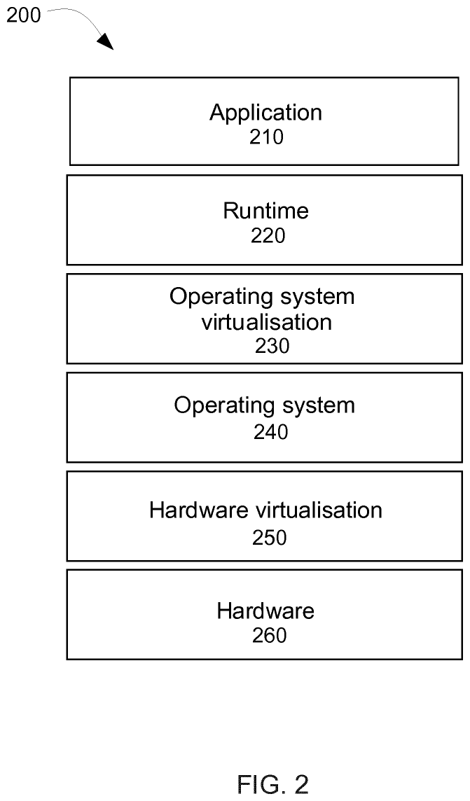

Although not illustrated in FIG. 1, in some embodiment the arrival time of a respective request 140 may be expressed in the format of signed or unsigned integers in 8-bit, 16-bit, 32-bit, or 64-bit. A number of advantages are associated with this particular format for expressing the arrival time. For example, with 64-bit CPUs being widespread, arrival times that are expressed in 64-bit integers can be compared quickly. As another example, the granularity offered by this format make it unlikely for two requests to share an arrival time. Also, as another example, arrival times expressed in this type of format can be quickly generated, for example at any level in the execution stack, e.g. those illustrated in FIG. 2.

The scheduling system 100 is configured to extend the network communication protocol to transmit, for each of the one or more requests 140a, 140b, 140c, respectively assigned global scheduling information 150 with the respect request via protocol extension associated with the network communication protocol, such that the respective global scheduling information 150 is made available to a local scheduling unit 130 corresponding to a host 112 via which the respective request 140 is transmitted.

As mentioned above, each of the plurality of local scheduling units 130a, 130b corresponds to one of the plurality of hosts 112a, 112b. According to the present embodiment, each of the plurality of local scheduling units 130a, 130b is configured to determine, for each of the one or more requests 140 received at the corresponding host 112, an order in which at least one of a computation operation, a communication operation, and an input/output operation associated with the respective request 140 is performed. The determination performed by the local scheduling unit 130 is based on the global scheduling information 150 assigned to the respective request 140.

In some embodiments, each of the plurality of local scheduling units 130a, 130b may be configured to determine the order in which at least one of a computation operation, a communication operation, an input/output operation associated with the respective request 140 is performed based on a first-come-first-served scheduling policy or an earliest-deadline-first scheduling policy, by prioritising requests 140 associated with the earliest arrival times. Alternatively or in addition, in some embodiments, each of the plurality of local scheduling units 130a, 130b may be configured to determine the order in which at least one of a computation operation, a communication operation, and an input/output operation associated with the respective request 140 is performed based on a least-attained-service scheduling policy, by prioritising requests 140 associated with at least one of: shorter amount of time serving the request and smaller amount of network data transmitted on behalf of the request.

Furthermore, in some embodiments, each of the plurality of local scheduling units 130a, 130b may be configured to update, for each of the requests received at the respective corresponding host 112, the respective global scheduling information 150 such that it comprises information associated with at least one of: an amount of time spent serving the respective request and an amount of network data transmitted on behalf of the respective request. For example, as shown in FIG. 1, the first local scheduling unit 130a is configured to update the global scheduling information 150 such that the global scheduling information 150 of the first request 140a comprises “service time” (i.e. an amount of time spent serving the respective request 140) which is represented by “5”, the global scheduling information 150 of the second request 140b comprises “service time” which is represented by “5”, and the global scheduling information 150 of the third request 140c comprises “service time” which is represented by “1”.

In the present embodiment as illustrated in FIG. 1, the scheduling system 100 comprises the distributed system 110, and therefore the plurality of hosts 112a, 112b of the distributed system 110. The plurality of hosts 112a, 112b may be configured to host one or more applications. Each of the one or more applications may comprise one or more application components. Furthermore, for each of the one or more applications hosted by the plurality of hosts 112a, 112b, the one or more application components may be configured to perform at least one of a computation operation, a communication operation, and an input/output operation corresponding to each of the one or more requests 140 received at the corresponding hosts 112 in the order determined by the corresponding local scheduling unit 130.

Those skilled in the art would appreciate that in alternative embodiments at least part of the distributed system 110 may not be part of the scheduling system 100. For example, in some embodiments, the plurality of hosts 112a, 112b may not be part of the scheduling system 100.

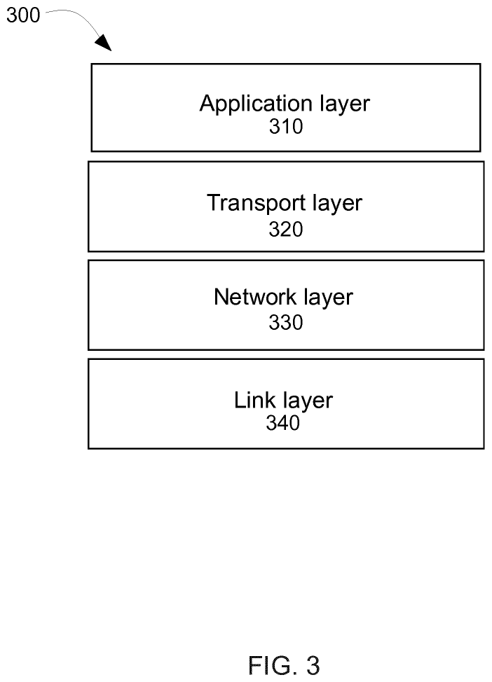

Although not shown in FIG. 1, the plurality of hosts 112a, 112b may be connected through a network stack comprising a plurality of layers. In these embodiments, the protocol extension may be implemented in at least one of the plurality of layers within the network stack. An exemplary structure of a network communication protocol stack is shown in the schematic diagram of FIG. 3. In more detail, as shown in FIG. 3, the exemplary network communication protocol stack 300 comprises an application layer 310, a transport layer 320, a network layer 330, and a link layer 340. Therefore, in some embodiments, the protocol extension may be implemented in at least one of the application layer 310, the transport layer 320, the network layer 330, and the link layer 340. In some embodiments a link layer tagging of IEEE 802.3 Ethernet Frames with global scheduling information, similar to 802.1q, may be implemented. In some other embodiments, a network layer extension, such as an IPv4 option or and IPv6 extension header may be implemented. In some embodiments, global scheduling information may be transmitted via a transport layer extension, such as a TCP option. Furthermore, in some embodiments global scheduling information may be transmitted via an application layer extension, such as an HTTP header.

It will be appreciated that FIG. 1 only shows the components required to illustrate an aspect of the scheduling system 100 and, in a practical implementation, the scheduling system 100 may comprise alternative or additional components to those shown.

FIG. 2 is a schematic diagram illustrating the structure of an execution stack, according to embodiments of the disclosure. As shown in FIG. 2, the execution stack 200 comprises application 210, runtime 220, operating system virtualisation 230, operating system 240, hardware virtualisation 250, and hardware 260. In some embodiments, local scheduling unit(s) may be implemented at one or more levels of the execution stack as shown in FIG. 2.

In more detail, in some embodiments computation, communication, and input/output operations issued by the application to the runtime 220 may be encapsulated in lightweight threads, such as events or go-routines. The runtime 220 may act as a local scheduling unit for the application. The runtime 220 may then issues system calls to the (potentially virtualized) operating system 240, said system calls being issues within one or more kernel threads. The operating system 240 kernel may act as a local scheduling unit ordering the kernel threads created by the runtime 220. Finally, the operating system 240 may run the operations on (potentially virtual) CPUs. If the CPUs are virtual, then a hypervisor may act as the local scheduling unit for ordering virtual CPU operations onto the hardware CPUs. Finally, in some embodiments the hardware CPU itself may schedule instructions onto the underlying arithmetic, memory or I/O units. The method according to the present disclosure may be implemented at one or more of these levels, whenever a local scheduling decision is involved. The place to implement ordering may be chosen depending on the information available from the upper execution level, on the level of congestion on the resources of the lower execution level, and/or on the network stack layer at which the global scheduling information is encapsulated. For example, in some embodiments global scheduling information may be transmitted via HTTP headers and perform local scheduling decisions in the runtime 220, whereas in other embodiments global scheduling information may be transmitted via IPv4 options and perform local scheduling decisions in the operating system 240 kernel.

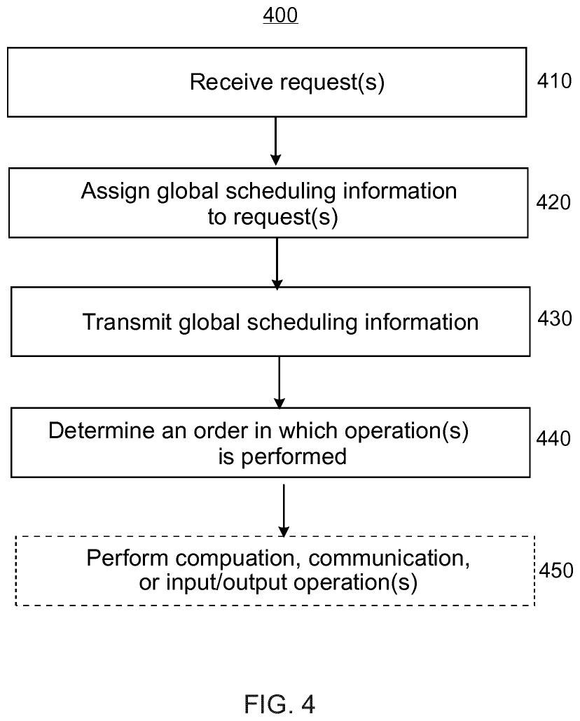

FIG. 4 is flowchart illustrating a method 400 for end-to-end request scheduling for a distributed system according to embodiments of the disclosure. The illustrated method can generally performed by or under the control of a scheduling system, for example the scheduling system 100 as described with reference to FIG. 1. For purposes of illustration, the method 400 will be described with reference to the various components of the scheduling system 100 and the distributed system 110 as shown in FIG. 1.

With reference to FIG. 4, at step 410, one or more requests are received. These requests correspond to the one or more requests that are transmitted via the plurality of hosts 112 in the distributed system 110. Upon receiving the one or more requests at the scheduling system 100, at step 420 global scheduling information is assigned to each of the one or more requests received at step 410. In some embodiments, the method 400 may be implemented at the scheduling system 100 which comprises an entry-point 120 and a plurality of local scheduling units 130 each corresponding to one of the plurality of hosts 112 in the distributed system 110. In these embodiments, the steps of receiving the one or more requests at step 410 and assigning global scheduling information at step 420 may be performed at the entry-point 120.

In some embodiments, global scheduling information assigned to each of the one or more requests at step 420 may comprise an arrival time of the respective request at the entry-point. An arrival time of a respective request at the entry-point may be expressed in the format of integers in 8-bit, or 16-bit, or 32-bit, or 64-bit.

Subsequent to global scheduling information being assigned, at step 430 for each of the one or more requests, respective assigned global scheduling information 150 is transmitted with the respective request, such that respective global scheduling information 150 is made available to a local scheduling unit 130 corresponding to a host 112 via which each of the plurality of requests 140 is transmitted. For example, for the first request 140a in the plurality of requests, the global scheduling information of the first request 140a can be made available to each of the one or more hosts 112 via which the first request 140a is transmitted. In embodiments where the scheduling system 110 extends a network communication protocol implemented by the distributed system 110, the transmission of the one or more requests may be performed via the network communication protocol implemented by the distributed system 110, and the transmission of the respectively assigned global scheduling information may be performed via a protocol extension associated with the network communication protocol.

Then, at step 440, for each of the one or more requests received at each of the plurality of hosts 112, an order in which at least one of: a computation operation, a communication operation, and an input/output operation associated with the respective request 140 is performed. This determination at 450 is based on the global scheduling information 150 assigned to the respective request. In some embodiments, the determination may be performed by a respective local scheduling unit 130 corresponding to the host 112.

In some embodiments, determining the order at step 440 may be based on a first-come-first-served scheduling policy or earliest-deadline-first scheduling policy. In more detail, requests associated with earlier arrival times are prioritised, i.e. the earlier the arrival time, the more the respective request is prioritised in the determined order. For example, referring to the exemplary arrival times shown in FIG. 1 for the first request 140a, the second request 140b, and the third request 140c, it is shown that the first request 140a has an earlier arrival time than the second request 140b, and the second request 140b has an earlier arrival time than the third request 140c. Therefore, if the determination at step 450 is at least in part based on a first-come-first-served scheduling policy or earliest-deadline-first scheduling policy, the determined order may be (from most prioritised to least prioritised): the first request 140a, the second request 140b, and the third request 140c.

In some embodiments, determining the order at step 440 may be based on a least-attained-service scheduling policy. In more detail, requests associated with at least one of: shorter amount of time serving the request and smaller amount of network data transmitted on behalf of the request are prioritised, i.e. the shorter the amount of time spent serving the request, and/or the smaller the amount of network data transmitted on behalf of the request, the more the respective request is prioritised in the determined order. For example, referring to the exemplary service times shown in FIG. 1 (between the first host 112a and the second host 112b), it is shown that the third request 140c has a shorter service time than the first request 140a or the second request 140b. Therefore, if the determination at step 450 is at least in part based on a least-attained-service scheduling policy, the determined order may prioritise the third request 140c over the first request 140a and the second request 140b.

The method may include an optional method step 450 in which at least one of a computation operation, a communication operation, and an input/output communication is performed by one or more application components, in the order determined by the corresponding local scheduling unit 130 at step 440. The one or more application components may be part of one or more applications that are hosted by the plurality of hosts 112.

Although not illustrated in FIG. 4, the method 400 may further comprise a step of updating, for each of the requests 140 received at the respective corresponding host 112, the respective global scheduling information 150 such that it comprises information associated with at least one of: an amount of time spent serving the respective request 140 and an amount of network data transmitted on behalf of the respective request 140. This updating step may be performed by a respective local scheduling unit 130 corresponding to the host 112.

Moreover, although not illustrated in FIG. 4, the method may further comprise a step of discarding, for each of the plurality of requests, information associated with an arrival time of the request. The discarding step is performed prior to assigning the global scheduling information, and the step may be performed by the entry-point 120 of the scheduling system 100.

Those who are skilled in the art would appreciate that in some embodiments the method steps illustrated in steps 430 to 450 may be performed in a different order. For example, in some embodiments after determining an order in which at least one of: a computation operation, a communication operation, and an input/output operation associated with a respective request is performed (step 440), and performing such operation(s) in the determined order (step 450), the method may return to step 430 at which the respective request is transmitted to another host with the respectively assigned global scheduling information.

For at least some of the embodiments of the disclosure, by tracking the global scheduling information (e.g. arrival time) of each user request throughout the distributed system and enforcing an end-to-end servicing order of requests, performance loss due to modularisation in multi-tiered or micro-service-based applications can be reduced.

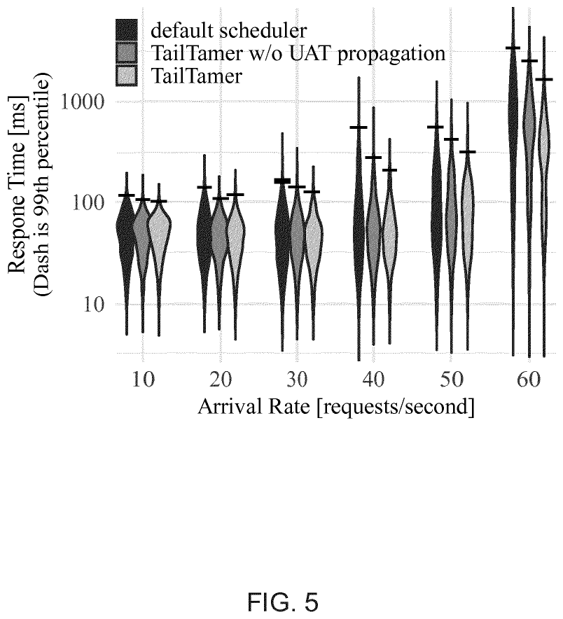

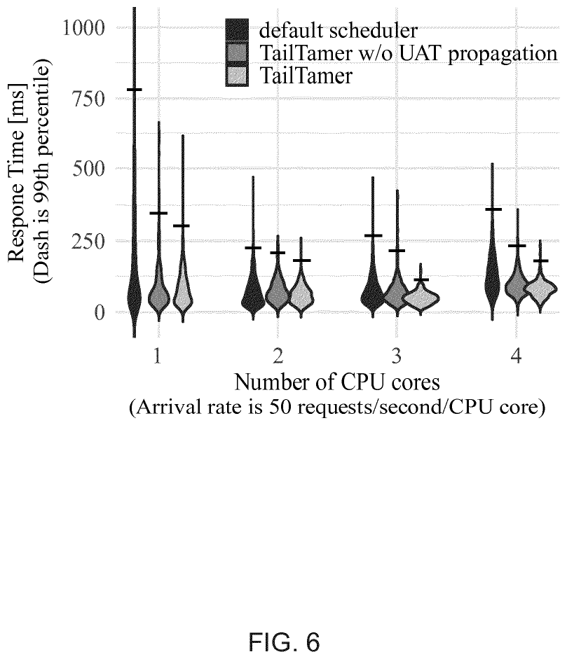

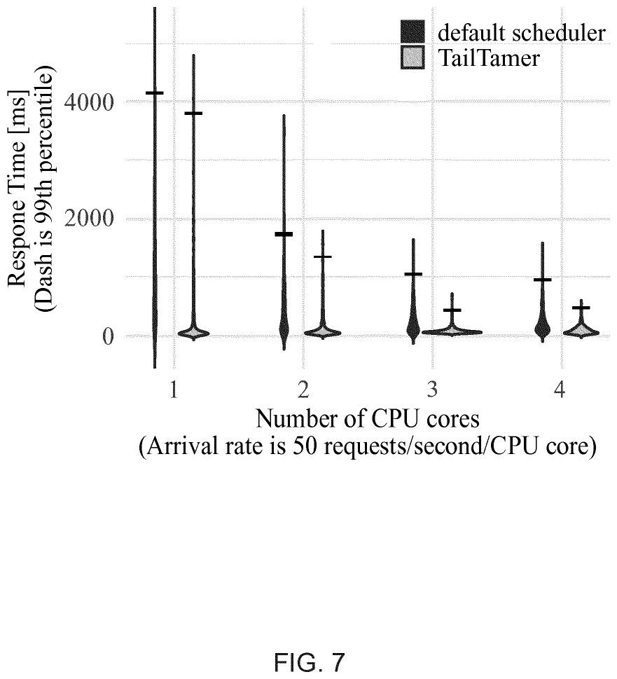

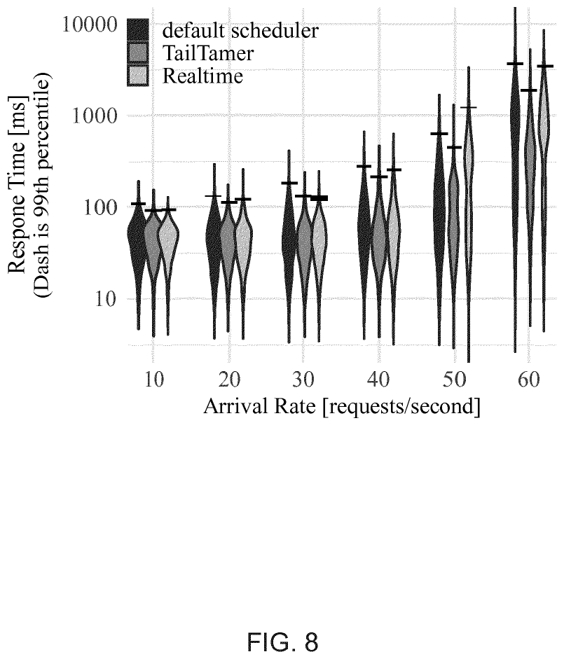

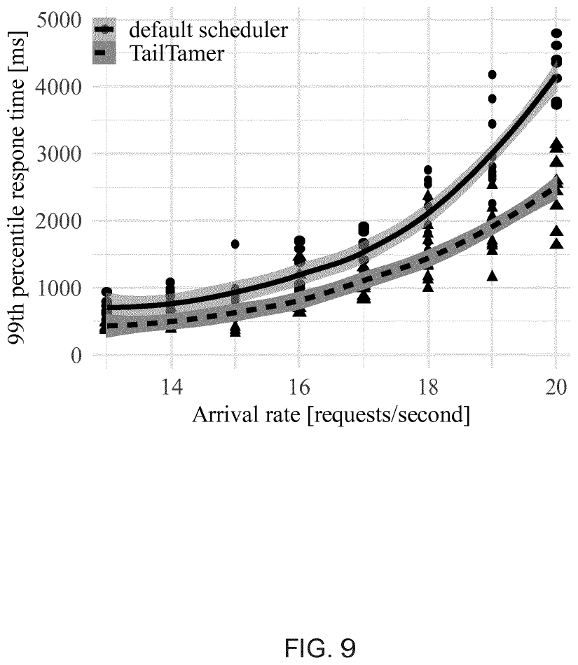

FIG. 5 to FIG. 9 are graphs illustrating results achieved by the method according to embodiments of the disclosure. In more detail, FIG. 5 illustrates results achieved by the method with increasing load, FIG. 6 illustrates results achieved by the method with increasing number of CPUs and constant load, FIG. 7 is illustrate results achieved by the method with co-located components, FIG. 8 illustrates results achieved by the method as compared with alternative approaches, and FIG. 9 illustrates results achieved by the method over three physical machines. The results show that the end-to-end scheduling technique according to embodiments of the disclosure can reduce tail response time by up to 50%, even when compared to a “near-ideal” approach that locally runs each request to completion.

The graphs as shown in FIGS. 5 to 9 are based on evaluation of performance gains that can be achieved using the method according to at least some embodiments of the disclosure, based on a number of experiments. The method according to embodiments of the disclosure will be referred to as “TailTamer” in the present context for FIGS. 5 to 9. In the TailTamer embodiment, IPv4 options are used as network protocol extension to transmit global scheduling information, perform local scheduling decisions in the operating system kernel, and order computation, communication, and/or input/output operations based on earliest arrival time at the entry-point expressed as a 64-bit integer representing the number of nanoseconds elapsed since the Unix epoch (Jan. 1, 1970 at 0:00:00 UTC), herein called Universal Arrival Time (UAT). It is noted that the UAT is not necessarily unique within the distributed system. The word “universal” in the present context denotes that said arrival time should be considered for local scheduling by all hosts in the distributed system. Although UAT is used in these evaluations, similar benefits can be expected with other embodiments. The focus of the evaluation is to compare the response time obtained using the default Linux scheduler (as is commonly deployed in the art) with TailTamer. The technique associated with embodiments of the present disclosure involves (1) reducing service time by reducing the number of context switches, and (2) using the same priority (based on global scheduling information) for all the queues throughout the system.

To better understand the contribution of each of two aspects, in some experiments (i.e. the experiments associated with the graphs shown in FIGS. 5 and 6) the results associated with a third scheduler is included. The third scheduler reduces context switches in the same manner as TailTamer, but does not propagate the arrival time (in the global scheduling information) to the next tier or component. This scheduler resembled a tandem queue with first-come-first-served (FCFS) per server, but not system-wide. In other words, each thread is prioritised based on the earliest arrival time of the request it served at each component. This is in contrast to TailTamer which prioritises threads based on the earliest arrival time at the first tier of the whole application pipeline.

The experiments associated with the graphs shown in FIGS. 5 to 8 were conducted on a single physical machine equipped with one Intel® Core™ i7-6700 processor and 32 GB of memory. Kernel-based Virtual Machine (KVM) was used as hypervisor, CoreOS was run as the guest operating system, and RUBiS (an e-commerce prototype) was deployed. In order to test that the arrival times (of the global scheduling information) are transmitted correctly over the (virtual) network, RUBiS was deployed in three Virtual Machines (VMs): lighttpd for load-balancing, Apache with mod-php for web serving, and MySQL for database.

In order to ensure that the results are reliable and unbiased, vmtouch utility was used to hold the database files in-memory, thus avoiding variance due to disk latency. Furthermore, in order to ensure the load generated in the same way during each experiment, the httpmon workload generator in open system model and the same sequence of exponentially distributed inter-arrival times were used. Also, no non-essential processes or cron scripts were running at the time of the experiments. For example, some Core OS services that might interfere with the experiments were masked.

Since the experimental setup for all of these experiments included diverse application structures (non-threaded event-driven, non-threaded process pool, thread-pool), the evaluation results are relevant for a wide range of applications.

In the graphs as shown in FIGS. 5 to 9, the x-axis represents an experimental parameter that is varied, e.g. the arrival rate or the number of CPU cores, and the results for various schedulers (including TailTamer) are presented along the x-axis to facilitate comparison. The y-axis represents the response time in milliseconds, with the response-time distribution presented as a violin plot (without trimming, i.e. including minimum and maximum values). The horizontal thickness of the area represents the relative number of response time values on the y-axis recorded throughout an experiment. The 99^{th} percentile response time is highlighted using a dash. It is noted that log scales are employed in FIGS. 5 and 8 in the y-axis.

Referring to the graph shown in FIG. 5, TailTamer was tested as the load is increasing. Each VM is allocated one virtual CPU core and each virtual CPU is pinned to a separate physical core. The load is increased from 10 requests per second to 60 requests per second. As can be predicted using queuing theory, as the arrival rate and the load are increasing, the response time (both in average and tail) increases. With a higher load, TailTamer performs better at reducing tail response time. For example, when the arrival rate is 60 requests per second, the 99^{th} percentile response time is reduced from 3.13 s to 1.57 s, a reduction of almost 50%. The results in FIG. 5 also highlight that reducing context switches, without consistently ordering requests throughout the system, only partially contributes to the performance of the technique as discussed in embodiments of the present disclosure. Indeed, besides reducing the number of context switches and the overall service time, TailTamer also reduces tail response times via propagation of arrival times, by ensuring that user requests are prioritised the same way at each component.

Referring to the graph shown in FIG. 6, TailTamer was tested as the number of cores allocated to a tier increase, but the load per core is kept constant at 50 requests per core per second. Only the database component is scaled, as it is the bottleneck of the application. TailTamer was tested with arrival rates to 50, 100, 150, and 200 requests per second, allocating one, two, three, and 4 CPUs to the database component, respectively. As can be predicted using queuing theory, increasing the number of CPUs (or servers, in queuing theory terminology) reduces both average and tail response times. However, ensuring consistent order based on arrival times (in the global scheduling information), as done by TailTamer, further reduces tail response time. For example, with four CPUs, the 99^{th} percentile response time is reduced from 349 ms to 220 ms, a reduction of over 30%. As with the experiment discussed with reference to FIG. 5, the results highlight that both service time reduction and arrival times are contributing to response time reduction.

One of the advantages of implementing TailTamer is that the technique runs in the kernel. This means that, in contrast to application-level scheduler, TailTamer is insensitive to several processes being co-located on the same resources an can potentially better deal with self-interference, i.e. the undesirable phenomenon of components of an application causing performance interference among themselves due to co-location. To illustrate this, the experiment associated with the graph of FIG. 7 is one that was based on the experiment discussed with reference to FIG. 6, but ran with Apache and MySQL running in the same VM, which has a single virtual CPU. No CPU pinning is performed within the VM, to ensure that the CPU of the VM can be fully utilised. In contrast, having Apache and MySQL pinned to virtual CPUs would lead to either of the two acting as a soft bottleneck, i.e. a bottleneck that appears despite idle physical resources.

Referring to the graph of FIG. 7, as expected both schedulers (i.e. default and TailTamer) are affected by co-location, since fewer physical CPUs need to be shared among Apache and MySQL. However, it is clear that TailTamer outperforms the default scheduler. Furthermore, compared to the experimented discussed with reference to FIG. 6, the method employed for the current experiment (FIG. 7) is less affected by co-location, e.g. at an arrival rate of 200 requests per second and four cores, the 99^{th} percentile response time increases by 50% compared to the previously discussed experiments, whereas for the default scheduler the increase is around 66%. It can therefore be concluded that TailTamer can reduce self-interference, and that the resulting increase in tail response time (as compared to the case when no co-location is performed) is less compared to the default scheduler, despite the reduced capacity available to the application.

Referring to the graph of FIG. 8, the associated evaluation is based on comparison of TailTamer with alternative approaches for dealing with scheduling delays. The graph in FIG. 8 shows the results which compare the performance of RUBiS when deployed with the default Linux scheduler, TailTamer, and the Linux Real-time scheduler. As can be observed, the real-time approach addresses some sources of scheduling delay, but it cannot effectively cope with tail response time reduction in distributed systems. Indeed, TailTamer outperforms the realtime scheduler at high loads. For example, when the arrival rate is 60 requests per second, the 99^{th} percentile response time is 3.15 s for the realtime scheduler, whereas TailTamer reduces response time to 1.71, representing a reduction of over 45%.

It is noted that the experiments associated with the graphs illustrated in FIGS. 5 to 8 were performed in a controlled network environment, i.e. the virtual network within a single physical machine. For the experiment associated with the graphs of FIG. 9, TailTamer was evaluated on a real local network with physical machines. In more detail, the experiment was conducted on three physical machines A, B, and C which are equipped with two AMD Operton™ 6272 processors and 56 GB of memory. The three machines were connected through a non-dedicated Gigabit switch. Ubuntu 16.04.3 LTS was used on top of which a custom Linux kernel with TailTamer, a Docer Engine 17.10.0-ce were deployed. Also, the workload generator and lighttpd were deployed to A, Apache and PHP were deployed to B, and MySQL was deployed to C. To make it easier to bring the system close to saturation, each container was limited to a single, exclusively-allocated CPU core.

Given the fact that experiments over a real network imply more variability, 10 repetitions for each arrival rate were performed. The focus of the experiments is on the 99^{th} percentile response time, and each measurement, the mean of the measurements and the 95% confidence intervals computed using the loess method were reported.

Referring to FIG. 9, it is shown that as the arrival time increases, the 99^{th} percentile response time increases for both the default scheduler and TailTamer, in agreement with queuing theory. It is observed that the 99^{th} percentile response time for TailTamer increases slower. In fact, the mean of the measurements for TailTamer are always lower than the default scheduler, no matter the arrival rate. At low arrival rates the confidence intervals overlap, which means it cannot be concluded (at 95% confidence) that TailTamer outperforms the default scheduler. However, starting with 15 requests per second, the two confidence intervals no longer overlap, and therefore it can be concluded (at 95% confidence) that TailTamer outperforms the default scheduler at high load. For example, at an arrival rate of 20 requests per second, the 99^{th} response time is reduced from 4.00 s to 2.89 s, representing a 27% improvement.

In summary of the results presented in the graphs of FIGS. 5 to 9, TailTamer significantly improves tail latencies compared to currently known scheduling algorithms by up to 50%, in particular when the system is operating at high utilisation or when application components are co-located.

Thus, embodiments of the present disclosure provide a method for end-to-end request scheduling which can reduce tail response time and can be readily employed without requiring changes to the application source code, and they are particularly beneficial at high load or when the application components are co-located. This translates into lower infrastructure cost and, given the lack of energy-proportional hardware, higher energy efficiency while ensuring good user experience without resorting to computing capacity over-provisioning. The method reduces tail response time at the boundary of the distributed system instead of reducing tail response time for individual components. Moreover, the method is application agnostic, hence applications can directly benefit from it without source code modifications and without using the same communication framework.

Embodiments of the disclosure also provide a scheduling system for performing end-to-end request scheduling at a distributed system comprising a plurality of hosts. The scheduling system extends a network communication protocol implemented by the distributed system.

There is also provided a computer program product comprising a computer readable medium, the computer readable medium having computer readable code embodied therein, the computer readable code being configured such that, on execution by a suitable computer or processor, the computer or processor is caused to perform the method or methods described herein. Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

An embodiment relating to a computer program product comprises computer-executable instructions corresponding to each processing stage of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

The above disclosure sets forth specific details, such as particular embodiments or examples for purposes of explanation and not limitation. It will be appreciated by one skilled in the art that other examples may be employed apart from these specific details.

1. A method for end-to-end request scheduling for a distributed system, the distributed system comprising a plurality of hosts via which one or more requests are transmitted, the method comprising:
receiving the one or more requests;
assigning global scheduling information to each of the one or more requests;
transmitting, for each of the one or more requests, respectively assigned global scheduling information with the respective request, such that respective global scheduling information is made available to a local scheduling unit corresponding to a host via which each of the plurality of requests is transmitted; and
determining, for each of one or more one or more requests received at each of the plurality of hosts, an order in which at least one of: a computation operation, a communication operation, and an input/output operation associated with the respective request is performed, wherein the determination is based on the global scheduling information assigned to the respective request.

2. The method according to claim 1, wherein the method is implemented at a scheduling system comprising an entry-point and a plurality of local scheduling units each corresponding to one of the plurality of hosts in the distributed system, wherein the steps of receiving the one or more requests and assigning global scheduling information are performed at the entry-point, and the step of determining an order in which at least one of a computation operation, a communication operation, and an input/output operation associated with a request is performed by a local scheduling unit corresponding to the respective host at which the respective request is received.

3. The method according to claim 1, wherein each of the plurality of hosts is configured to host one or more applications, each of the one or more applications comprising one or more application components, the method further comprising:
performing, by the one or more application components, at least one of a computation operation, a communication operation, and an input/output operation corresponding to each of the one or more requests received at the respective corresponding hosts in the order determined by the corresponding local scheduling unit.

4. The method according to claim 2, wherein the global scheduling information assigned to each of the one or more requests comprises an arrival time of the respective request at the entry-point.

5. The method according to claim 4, wherein an arrival time of a respective request at the entry-point is expressed in the format of integers in 8-bit, or 16-bit, or 32-bit, or 64-bit.

6. The method according to claim 4, wherein determining the order in which at least one of a computation operation, a communication operation, and an input/output operation associated with the respective request is performed based on a first-come-first-served scheduling policy or earliest-deadline-first scheduling policy, by prioritizing requests associated with the earliest arrival times.

7-9. (canceled)

10. A computer program product comprising a computer readable medium, the computer readable medium having computer readable code embodied therein, the computer readable code being configured such that, on execution by a suitable computer or processor, the computer or processor is caused to:
receive one or more requests;
assign global scheduling information to each of the one or more requests;
transmit, for each of the one or more requests, respectively assigned global scheduling information with the respective request, such that respective global scheduling information is made available to a local scheduling unit corresponding to a host via which each of the plurality of requests is transmitted; and
determine, for each of one or more one or more requests received at each of the plurality of hosts, an order in which at least one of: a computation operation, a communication operation, and an input/output operation associated with the respective request is performed, wherein the determination is based on the global scheduling information assigned to the respective request.

11. A scheduling system for performing end-to-end request scheduling at a distributed system comprising a plurality of hosts via which one or more requests are transmitted, wherein the scheduling system extends a network communication protocol implemented by the distributed system and comprises:
an entry-point configured to receive the one or more requests and to assign global scheduling information to each of the one or more requests; and
a plurality of local scheduling units, wherein each of the plurality of local scheduling units corresponds to one of the plurality of hosts in the distributed system,
wherein the scheduling system is configured to extend the network communication protocol to perform the following:
transmitting, for each of the one or more requests, respectively assigned global scheduling information with the respective request via a protocol extension associated with the network communication protocol, such that the respective global scheduling information is made available to a local scheduling unit corresponding to a host via which the respective request is transmitted,
wherein each of the plurality of local scheduling units is configured to determine, for each of one or more one or more requests received at the corresponding host, an order in which at least one of a computation operation, a communication operation, and an input/output operation associated with the respective request is performed, wherein the determination is based on the global scheduling information assigned to the respective request.

12. The scheduling system according to claim 11, further comprising the plurality of hosts, wherein each of the plurality of hosts is configured to host one or more applications, each of the one or more applications comprising one or more application components,
wherein, for each of the one or more applications, the one or more application components are configured to perform at least one of a computation operation, a communication operation, and an input/output operation corresponding to each of the one or more requests received at the respective corresponding hosts in the order determined by the corresponding local scheduling unit.

13. The scheduling system according to claim 11, wherein the global scheduling information assigned to each of the one or more requests comprises an arrival time of the respective request at the entry-point.

14. The scheduling system according to claim 12, wherein an arrival time of a respective request at the entry-point is expressed in the format of integers in 8-bit, or 16-bit, or 32-bit, or 64-bit.

15. The scheduling system according to claim 13, wherein each of the plurality of local scheduling units is configured to determine the order in which at least one of a computation operation, a communication operation, an input/output operation associated with the respective request is performed based on a first-come-first served scheduling policy or an earlier-deadline-first scheduling policy, by prioritizing requests associated with the earliest arrival times.

16. The scheduling system according to claim 11, wherein each of the plurality of local scheduling units is configured to update, for each of the requests received at the respective corresponding host, the respective global scheduling information such that it comprises information associated with at least one of: an amount of time spent serving the respective request and an amount of network data transmitted on behalf of the respective request.

17. The scheduling system according to claim 16, wherein each of the plurality of local scheduling units is configured to determine the order in which at least one of a computation operation, a communication operation, and an input/output operation associated with the respective request is performed based on a least-attained-service scheduling policy, by prioritizing requests associated with at least one of: shorter amount of time serving the request and smaller amount of network data transmitted on behalf of the request.

18. The scheduling system according to claim 11, wherein the each of the plurality of local scheduling units is implemented in at least one of a level of an execution stack, wherein the execution stack comprises at least one of: a runtime environment, an operating system, and a hypervisor.

19-21. (canceled)
